(19) United States
(12) Patent Application Publication
(10) Pub. No.: US 2007/0124187 A1
(43) Pub. Date: May 31, 2007

(54) Cross system workflow manager

(76) Inventor: Manjit Singh Rajput, (US)

Correspondence Address: KENYON & KENYON LLP, ONE BROADWAY, NEW YORK, NY, 10004, US

(21) Appl. No.: 11/290,943

(22) Filed: Nov. 29, 2005

(51) Int. Cl. G05B 19/418

(52) U.S. Cl. 705/8

(57) ABSTRACT

A cross system workflow management system includes a memory device storing an instruction set. The instruction set includes a plurality of instructions, each instruction having an execution command and a system identifier. The instruction set may also include a data set. A central processing system includes a task processing device. The central processing system receives the instruction set from the memory device. The task processing device routes the first execution command to a first processing device in a first processing environment based on a first system identifier. The first processing device performs the designated operation, generating a data set. Upon completion, the task processing device routes a second execution command to a second processing device based on the second system identifier. The second processing device is disposed in a second processing environment that is different from the first processing environment.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to the management of a workflow operation performed by processing devices and more specifically to the management of the execution of multiple operations performed by different processing systems.

In existing multi-environment processing systems, workflows are self-contained. A workflow, such as through a template of functions, defines various steps for a specific operation. Current systems typically only provide for workflows within the systems themselves and does not provide for workflows across different systems. If the workflow can be across systems, they are typically limited to systems within the same processing environment, for example on the same proprietary operating platform.

For example, if a workflow provides for a user to request vacation time, a Human Resources system may include a workflow for performing this operation. The workflow may include a first step of loading a vacation request form for the employee to fill out. Once completed, the workflow may include commands for the form to be submitted to a supervisor or human resource person, for review. A next step may include supervisor approval or rejection. After approval or rejection, the employee may then be notified of the status of the vacation request. A final step may be updating a vacation-day data field in the human resource system for tracking the employee's number of vacation days.

In the above example, the workflow is specifically limited to the human resource system and the workflow does not include steps for other systems where these other systems are in a different processing environment. For example, the workflow does not access an employee schedule database to update an employee's electronic calendar to indicate they are out of the office for the particular days if the calendar database is in a different proprietary application than the human resource application. In another example, the workflow does not access a payroll system in case an employee's pay is adjusted based on the vacation time or if an external record of vacation days are tracked in the payroll system.

Therefore, under current existing systems, a user must manually access these different systems. Using the above example, a user must manually update the employee's electronic calendar and another user would have to input information into the payroll system. Generally speaking, the first system may provide output signals capable of being provided to other processing systems. These output signals, being input signals for the second system, may be used to perform further operations, but this requires the first system to generate the correct data and the second system to be programmed to receive the data.

This approach may be problematic for many reasons. First off, these technique requires that the two systems be fully interoperable and have the ability to communicate data. For example, the first system and the second system would either need to be in the same processing environment or one or both systems include translation techniques for communicating therebetween. This either requires a system to utilize applications within the same processing environment or each application to include proxies for cross-communication. Based on the wide availability of different processing systems in different environments, requiring identical processing environments or proxies not only increases processing overhead but can drastically limit options available for either creating or integrating processing systems.

Another problem with the above technique is that there is no management between these two systems and there is no assurance of interoperability. When the first system outputs data, it is assumed that the data is not only correct, but properly received by the second system. If there is an error in the transmission, neither system will be made aware of this. The first system simply generates the output and its task is complete. The second system either isn't aware that it was supposed to receive a signal or the signal it receives may be incorrect, but the second system cannot discern that. Furthermore, an error in one system may not necessarily be reflected in the other systems. For example, if a minor change is made in the first system, this may not be reflected in the second system.

Any problems associated with the above technique are only further multiplied when dealing with numerous processing systems having different processing environments. As different systems provide greater degrees of functions and interoperability, it is important to allow workflows across these different systems. Even further, as different systems include different formats and proprietary functions, it is important to provide workflows across non-interoperative systems, insuring the successful completion of the steps of the workflow task, as well as insuring the operability of the different systems as one processing entity.

### BRIEF DESCRIPTION OF THE DRAWINGS

FIG. 1 illustrates a block diagram of one embodiment of a system capable of managing cross system workflow operations;

FIG. 2 illustrates a graphical representation of one embodiment of an instruction set usable by the system of FIG. 1;

FIG. 3 illustrates another embodiment of a system capable of managing cross system workflow operations; and

FIG. 4 illustrates the steps of one embodiment of a method for managing cross system workflow.

### DETAILED DESCRIPTION

As the interoperability of different specialized processing systems increase, managing operations between these systems becomes increasingly important. A central processing system manages interaction between different specialized processing systems. A cross system workflow management system processes instruction sets, where the instruction sets include execution commands having system identifiers. With the inclusion of the system identifier, the management system coordinates and controls the operation of different functions in different processing systems. The different systems may be in different processing environments, therefore through the management system, previously non-interoperable systems can perform various functions of the instruction set relating to a particular function.

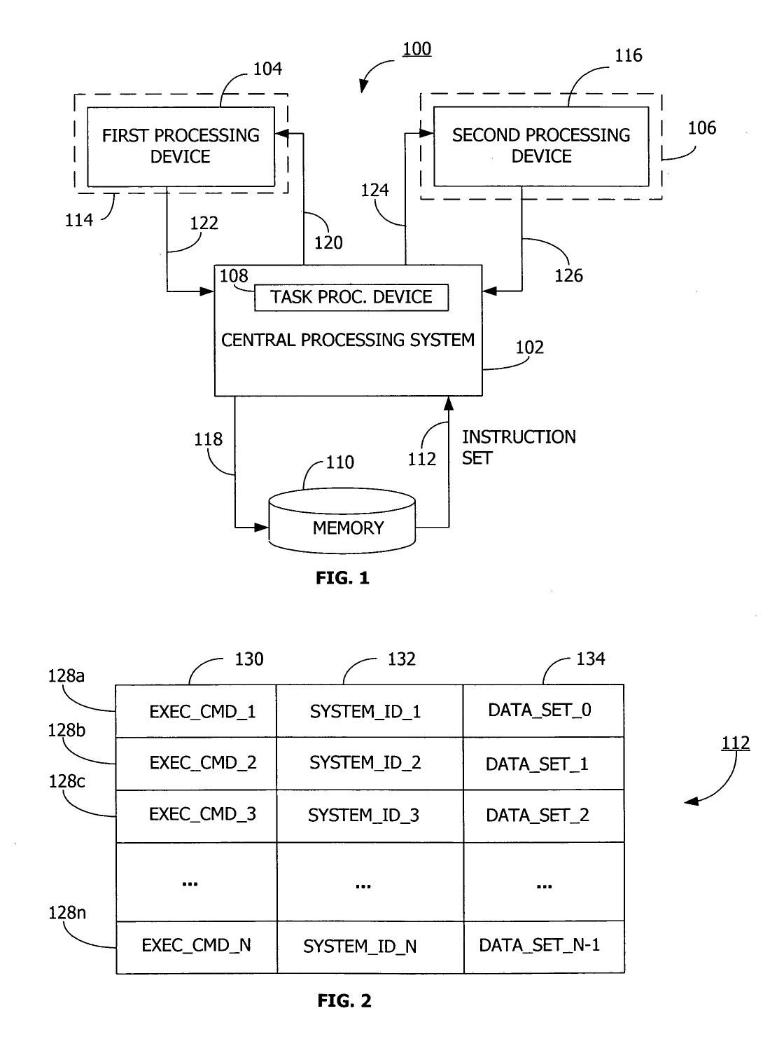

FIG. 1 illustrates a processing system 100 including a central processing system 102, a first processing device 104 and a second processing device 106. The central processing system 102 includes a task processing device 108 executable therein. The system 100 further includes a memory device 110 in communication with the central processing system 102 for providing instruction sets 112 thereto.

The central processing system 102 allows for multi-system operation through interfacing and managing computational activities between the different processing device 104 and 106. In one embodiment, the central processing system 102 may include functionality as found in the NetWeaver operating system available from SAP.

The first processing device 104 is disposed in a first processing environment 114. The second processing device 106 is disposed in a second processing environment 116. These processing environments 114 and 116 may be different operating platforms, such as proprietary platforms that may not be readily compatible with each other. The processing devices 104 and 106 perform programming functions based on embedded encoding. For example, the first processing device may be a human resource system that performs various management functions using encoded instructions readable by the first processing environment 114. In another example, the second processing device 106 may be a payroll system that performs various payroll functions using instructions encoded in a language readable by the second processing environment 116.

The task processing device 108, disposed within the central processing system 102, monitors the execution of the execution commands within the instruction set 112 retrieved from the memory 110. The task processing device 108 includes directing which processing device, for example 104 or 106, executes a particular operation and which, if any data, from the central processing system is included for the execution of the particular step.

To execute a task, the central processing system 102 sends an instruction set retrieval request 118 to the memory device 110. In accordance standard data retrieval techniques, the memory 110 provides the instruction set 112 to the central processing system 102 and execution commands are extracted from the set 112. The execution commands are one or more data identifiers used to indicate a particular task, for example the execution command may be a call command that a subsequent processing device recognizes for launching a corresponding application. The task processing device may provide input data for the processing device or in another embodiment, the processing device may request data from a user through existing interface techniques.

In response to the instruction set, the task processing device 108 provides a first execution command 120 to the first processing device 104. Based on this command, the processing device 104 performs the directed function. For example, if the first processing device 104 is a human resource system and the instruction set relates to a vacation day, the function may be the internal processing of a vacation request form. In this example, the completion of this process may be when a supervisor electronically approves the vacation request.

Once this task is completed, a completion command 122 is provided to the central processing system 102. The completion command 122 may include data from the first processing device 104 that is usable for other processes. For example, if the first processing device 104 is the human resource system and the function relates to a vacation request form, the completion command 122 may include information relating to the particular vacation days, the employee's identification and the approving supervisor's identification code. The central processing system 102, in central communicating between different systems in different environments, for example 114 and 116, translates this information for use by other systems. This translation may be performed by known translating techniques to convert any proprietarily encoded data into a general format that may used by the central processing system 102 or converted for usage by other processing devices in other environments.

If further instructions are in the instruction set 112, the task processing device 108 further processes the steps of the instruction set 112. If the second execution command includes a system identifier directed to the second processing device 106, the task processing device 108 transmits the second execution command 124 to the second processing device 106. If the execution command 124 includes additional data, such as data received from the completion command 122, the central processing system 102 may convert this data into an acceptable encoding for use by the second processing device 124. Similar to the decoding of the data from the completion command 122, the central processing system 102 may use known translation techniques to prepare any data included with the execution command 124 to be readable by the second processing device 106.

Upon receipt of the second execution command, the second processing device 106 performs the requested operation. Using the above example of a vacation request, the second processing device 106 may be a payroll system that tracks vacation days for determining the employee's proper compensation. The command 124 may include data to launch an application for tracking the employee's vacation days. The command 124 may also include data that can be utilized for performing this task. In another embodiment, the second processing device 106 may include interactive functionality so that one or more users must provide input to complete the underlying task. For example, in the payroll embodiment, a payroll supervisor may be required to enter the supervisor's identification code to acknowledge approval and processing of the vacation day request.

The second processing device 106, upon completing the task provides a second completion command 126 to the central processing system 102 to indicate the task is completed. In the embodiment where the task is an automated task, the completion command 126 may be received also immediately after the execution command 124 is transmitted, depending on the processing load of the second processing device. Where the task utilizes user interaction, the completion command 126 may be received after a fair amount of delay. Therefore, the task processing device 108 may queue the particular instruction set 112 and manage other instruction sets (not shown) in proper course. The task processing device 108 may therefore control the operation of the instruction set by delaying steps until previous steps are completed and insure that later steps are executed after previous steps are successfully completed.

FIG. 2 illustrates a graphical illustration of the instruction set 112 that is retrievable from the memory 110 of FIG. 1. The instruction set 112, as discussed above, is a collection of data fields that are processed by the task processing device 108 of FIG. 1 for controlling various operations performed by different processing devices. The instruction set 112 includes a plurality of instructions 128, illustrated in FIG. 2 as fields 128a, 128b, 128c and 128n to represent that a varying number of instructions 128 are envisioned in the instruction set 112 based on the underlying task and the processing devices associated with the central processing system 102 of FIG. 1.

Illustrated in FIG. 2, there are n number of commands where n is an integer value. Each of the commands 128 includes an execution command 130, a system identifier 132 that identifies which system and subsequently which processing device 104 is to perform the particular task. The system identifier 132 may be any suitable data structure allowing for task processing device to coordinate and facilitate the delivery of the execution command 130. For example, the system identifier 132 may include a list of system capable of performing a particular function and the central processing system (102 of FIG. 1) determines from this list which system to forward the command 130. Other embodiments are envisioned, such as the instruction set being coded for the central processing system so that system identifier 132 is a routing command indicating the location for the task processing device 108 of FIG. 1 to route the execution command 130.

Also illustrated in FIG. 2, the instructions 128 include a data set field 134. In some embodiments, this data set field 134 may be empty or omitted, whereas data used for completing the execution command 130 is retrieved within the processing system. In other embodiments, this data set 134 includes data received either from an input device to the central processing system (108 of FIG. 1) or data that is received in completion commands (such as command 122 of FIG. 1). This data may be translated by the central processing system if the next command is to be executed by a processing device within a different processing environment.

With the system identifier 132, the task processing device 108 is able to properly route the execution commands 130 to the processing systems. As the task processing device 108 progresses down the instruction set 112, each subsequent command 130 is transmitted to the indicated system (based on the identifier 132) with the appropriate data set 134 associated therewith. This allows for the management of workflow as defined by the instruction 128 of the instruction set 112 across different processing systems in different processing environments.

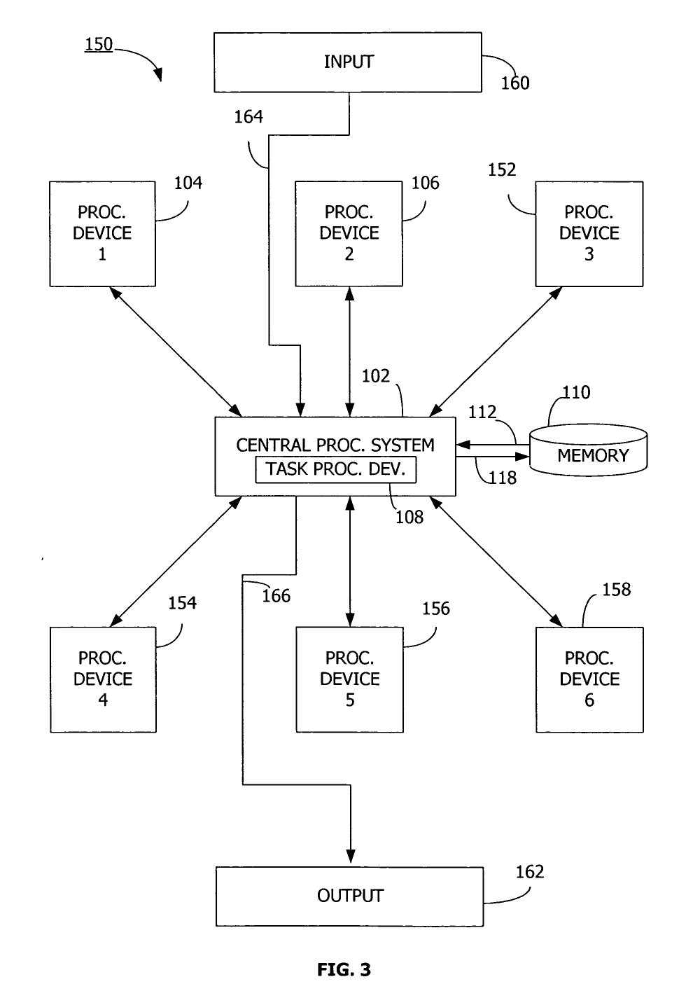

FIG. 3 illustrates one embodiment of a system 150, similar to system 100 of FIG. 1 including the central processing system 102, the task management device 108, the memory 110, the first processing device 104 and the second processing device 106. The system 150 further includes additional processing devices, third processing device 152, fourth processing device 154, fifth processing device 156 and a sixth processing device 158. In communication with the central processing system 102 are an input device 160 and an output device 162.

The processing devices 152, 154, 156 and 158 (collectively indicated as 152-158) are similar to the processing devices 104 and 106. These devices may be in one or more different processing environments, where these environments may be compatible with each other and these environments may also be incompatible with some or all of the other systems. In other words, the processing devices may be associated with any one of numerous proprietary processing environments offering applications in the native environment but allowing for communication with and through the central processing system 102.

In one embodiment, an input command 164 is provided from the input device 160 to the central processing system 102. This input command 164 may be a command to execute a particular function, such as the above-describe example to process a vacation request form. The processing device 102 thereupon retrieves the corresponding instruction set 112 from the memory 110 using the retrieval request 118. Similar to the above-described embodiment, the task processing device 108 manages the execution of various steps of the instruction set 112 based on directed the executable commands (130 of FIG. 2) based on the system identifier (132 of FIG. 2).

Illustrated in FIG. 3, the central processing system 102 may be in communication with a large number of different processing devices 104, 106, and 152 - 158. Even though these devices may be incompatible, the central processing system 102 coordinates between these difference systems and provides for data and system interaction through proper translation.

Therefore, in this embodiment, the instruction set may include execution commands for any one of the processing devices 104, 106 and 152-158. Through execution of directed functions, the data sets are generated and utilized, if needed, for later steps. It is noted that the data sets may not necessarily be the same data that is generated from an immediately previous step, but may include input data from the input device or data from any of the previous steps, as needed by the processing device executing the command.

Using the above-example of vacation days, the first device 104 being a human resource application and the second device 106 being a payroll application, the other processing devices 152-158 may relate to other applications. For example, device 152 may relate to a calendar application automatically updating an electronic date book to reflect the vacation days. For example, processing device 154 may be a phone switching system to re-route the employee's incoming phone calls to another individual or to engage an automatic out-of-office message. In another example, processing device 156 may be an electronic mail communication system to institute an auto-reply feature indicating the employee is on vacation and the anticipate date of return to the office. In yet another example, processing device 158 may be a billing application to indicate that the employee will not enter any billing time entries for the vacation-noted days. These above are illustrative examples only and other applications for various levels of functions, not just limited to vacation planning, are envisioned, where these tasks include multiple steps across multiple processing systems.

Once all of commands of the instruction set 112 have been processed, the central processing system 102 generates an output command 166 and provides this command to the output device 162. The output command 166 may be a visual indicator to an output display indicating the successful completion of each of the steps, such as indicating that the vacation has been approved for the defined days, the person has X number of vacation days left, the calendar, voicemail and electronic mail systems have updated and the billing system reflects the employees upcoming absence. It is also noted that updates may be provided to the output device 162 as each step is completed, such as in a piecemeal fashion. It is also noted that the output may be an output simply indicating the tasks having been completed, such as a confirmation electronic communication to the employee. Therefore, through the task processing device 108 of the central processing system 102, the workflow operations to be performed across potentially incompatible processing systems is properly managed.

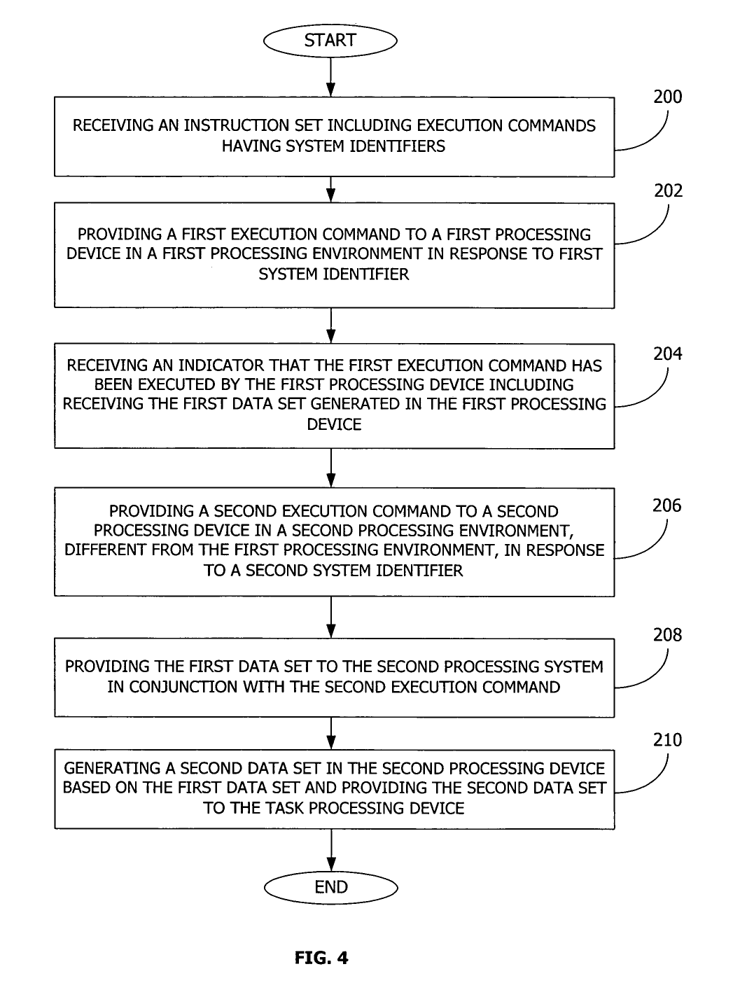

FIG. 4 illustrates a flowchart of the steps of one embodiment of a method for managing workflow across different processing systems. The method begins, step 200, by receiving an instruction set including execution commands having system identifiers. For example, instruction set 112 includes the system identifiers 132 indicating which processing system is to execute a particular command. The next step, step 202, is providing a first execution command to a first processing device in a first processing environment in response to the first system identifier. As illustrated above, the system 104 is provided the first execution command 120 based on the system identifier 132.

The next step, step 204, is receiving an indicator that the first execution command has been executed. As discussed above, this step may include receiving the first data set generated in the first processing device. This data set 122 may be received by the central processing system 102. The next step, step 206, is providing a second execution command to a second processing device in a second processing environment, different from the first processing environment, in response to a second system identifier. As discussed above, the execution command 124 is provided to the processing device 106 based on the system identifier 132 of the execution set 112 of FIG. 2 where the second processing environment 116 is different from the first processing environment 114.

The next step, step 208, in one embodiment, is providing the first data set to the second processing device in conjunction with the second execution command. The first data set 134 may be included the execution of the second command 130 as it may be based on information acquired or generated in the first command 130. The next step, step 210, is generating a second data set in the second processing device based on the first data set and providing the second data set to the task processing device. This data set may be included in the command 126 as received by the central processing system 102. Thereupon, the central processing system uses the task processing device 108 to manage workflow operations to be performed by different systems in different processing environments.

As such, workflow operations may be conducted across different processing devices executing in different processing environments. A task in a first system may be coordinated with tasks in other systems to significantly improve cross-system workflow. Where previously independent processing devices conducted specific operations, the central processing system and the task processing device coordinate and control the operation of these instruction sets across the different processing environments. Not only are more global procedures available, such as the example of performing numerous different operations relating a vacation request, but the manual interface for multiple systems is reduced and the cross system workflow is effectively automated. Moreover, the cross system workflow is properly managed by the central processing system, including the transmission of the proper data sets used in the various execution commands instead of requiring further levels of user interaction to not only launch the related applications, but also perform the execution commands and process and/or generate the proper data.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A cross system workflow management system comprising:
a memory device storing an instruction set including a plurality of instructions, each instruction having execution commands having corresponding system identifiers;
a central processing system including a task processing device receiving the instruction set from the memory device;
a first processing device in a first processing environment receiving a first execution command from the task processing device based on a first system identifier; and
a second processing device in a second processing environment, different from the first processing environment, receiving a second execution command from the task processing device based on a second system identifier after the completion of the first execution command by the first processing device.

2. The system of claim 1 further comprising:
the first processing device generating a first data set in response to the first execution command; and
the central processing system providing the first data set to the second processing device in conjunction with the second execution command.

3. The system of claim 2 further comprising:
the second processing device generating a second date set based on the first data set.

4. The system of claim 3 further comprising:
an output device receiving an output command from the central processing system, the output command generated based on the first data set and the second data set.

5. The system of claim 1 further comprising:
a third processing system in a third processing environment in communication with the central processing system to receive a third execution command from the task processing device based on a third system identifier.

6. The system of claim 5 further comprising:
the first processing device generating a first data set in response to the first execution command and providing the data set to the second processing device through the central processing system in conjunction with the second execution command;
the second processing device generating a second data set based on the first data set; and
the third processing system generating a third data set based on at least one of the first data set and the second data set.

7. A cross system workflow management method comprising:
receiving a instruction set including a plurality of instructions, each instruction having execution commands having corresponding system identifiers;
providing a first execution command to a first processing device in a first processing environment in response to first system identifier;
receiving an indicator that the first execution command has been executed by the first processing device; and
providing a second execution command to a second processing device in a second processing environment, different from the first processing environment, in response to a second system identifier after the completion of the first execution command.

8. The method of claim 7 further comprising:
generating a first data set in the first processing device; and
providing the first data set to a task processing device in a central processing system.

9. The method of claim 8 further comprising:
providing the first data set to the second processing device in conjunction with the second execution command.

10. The method of claim 9 further comprising:
generating a second data set in the second processing device based on the first data set.

11. The method of claim 10 further comprising:
providing the second data set to the task processing device.

12. The method of claim 10 further comprising:
generating an output command based on the first data set and the second data set; and
providing the output command to an output device.

13. The method of claim 7 further comprising:
providing a third execution command to a third processing system in a third processing environment, in response to a third system identifier.

14. The method of claim 13 further comprising:
generating a first data set in the first processing device;
providing the first data set to the second processing device in conjunction with the second execution command;
generating a second data set in the second processing device based on the first data set;
providing the second data set to the third processing system in conjunction with the third execution command; and
generating a third data set in the third processing system.

15. Software for cross system workflow management, the software embodied in a computer-readable medium and, when executed on a processing device, operable to:
retrieve an instruction set including a plurality of instructions, each instruction having execution commands having corresponding system identifiers;
provide a first execution command from the instruction set to a first processing device in a first processing environment in response to first system identifier;
receive a first data set generated in the first processing device in response to the first execution command; and
provide a second execution command to a second processing device in a second processing environment, different from the first processing environment, in response to a second system identifier after the execution of the first execution command.

16. The software of claim 15 further operative to:
provide the first data set to the second processing device in conjunction with the second execution command.

17. The software of claim 16 further operative to:
receive a second data set generated in the second processing device based on the first data set in response to the second execution command.

18. The software of claim 17 further operative to:
receive the second data set in the task processing device.

19. The software of claim 17 further comprising:
generate an output command based on the first data set and the second data set; and
provide the output command to an output device.

20. The software of claim 15 further operative to:
provide a third execution command to a third processing system in a third processing environment, in response to a third system identifier.

21. The software of claim 20 further operative to:
provide the first data set to the second processing device in conjunction with the second execution command;
receive a second data set generated in the second processing device based on the first data set in response to the second execution command;
provide the second data set to the third processing system; and
receiving a third data set generated in the third processing system.
